(19) United States
(12) Patent Application Publication
(10) Pub. No.: US 2017/0212902 A1
(43) Pub. Date: Jul. 27, 2017

(54) PARTIALLY SORTED LOG ARCHIVE

(71) Applicant: Hewlett Packard Enterprise Development LP, Houston, TX (US)

(72) Inventor: Goetz Graefe, Madison, WI (US)

(21) Appl. No.: 15/314,751

(22) PCT Filed: May 30, 2014
(86) PCT No.: PCT/US2014/040321

§ 371 Date: Nov. 29, 2016

(51) Int. Cl. G06F 17/30; G06F 11/14; G06F 7/08

(52) U.S. Cl. CPC G06F 17/30073; G06F 17/30368; G06F 7/08; G06F 11/1469; G06F 2201/84

(57) ABSTRACT

Systems and methods associated with an at least partially sorted log archives are disclosed. One example method for restoring a database includes restoring members of a set of database pages originally stored on a failed media device in the database. Restoring a member of the set of pages includes loading an image of the member of the set of database pages from a backup. Restoring the member of the set of database pages also includes applying log entries associated with the member of the set of database pages to the image. The log entries may have been recorded after the image of the member of the set of database pages was taken. The log entries may be retrieved from the at least partially sorted log archive. Restoring the member of the set of database pages also includes writing the database page to a replacement media.

### BACKGROUND

Instead of having one large storage media, some data stores often employ several smaller storage media that store portions of the data store. The data stores are sometimes periodically duplicated to backup media (e.g., a tape drive). Between backups, changes to the data store may be stored in a log archive, which describes state changes of pages that have occurred since the most recent backup. While these changes are waiting to be moved to the log archive, the state changes may be temporary stored in a recovery log. The recovery log may be stored on a reliable, persistent, fast media, and may have limited size (e.g., flash memory, non-volatile memory).

### BRIEF DESCRIPTION OF THE DRAWINGS

The present application may be more fully appreciated in connection with the following detailed description taken in conjunction with the accompanying drawings.

FIG. 1 illustrates example data structures associated with partially sorted log archives.

FIG. 2 illustrates a flowchart of example operations associated with partially sorted log archives.

FIG. 3 illustrates another flowchart of example operations associated with partially sorted log archives.

FIG. 4 illustrates another flowchart of example operations associated with partially sorted log archives.

FIG. 5 illustrates another flowchart of example operations associated with partially sorted log archives.

FIG. 6 illustrates an example system for facilitating partially sorted log archives.

FIG. 7 illustrates another example system for facilitating partially sorted log archives.

FIG. 8 illustrates another example system for facilitating partially sorted log archives.

FIG. 9 illustrates an example computing environment in which example systems and methods, and equivalents, may operate.

FIG. 10 illustrates example structures on which example systems and methods, and equivalents, may operate.

### DETAILED DESCRIPTION

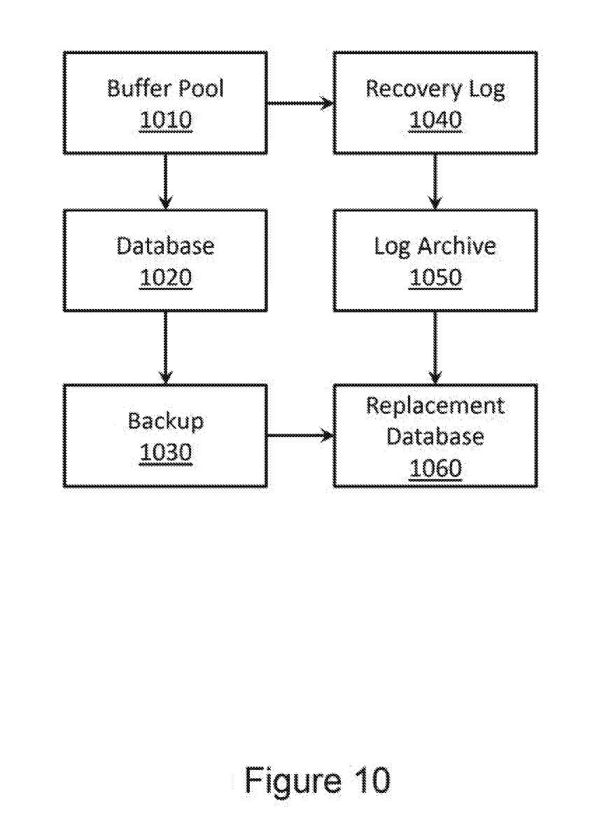

Systems and methods associated with partially sorted log archives are described. FIG. 10 illustrates example memory structures on which example systems and methods, and equivalents, may operate, and is useful for providing context for when and where various actions occur at various levels of memory in a database. In a database, transactions occur in a buffer pool 1010. For example, in a structured query language (SQL) database, in response to a query, a page associated with the query may be loaded into an in-memory buffer pool 1010 from a live version of a persistent database 1020 (as opposed to a backup 1030 of database 1020). The page may be modified based on the query, and then queued for being recommitted to database 1020. Database 1020 may be periodically backed up to backup 1030, which attempts to store long term snapshots of database 1020 in the event of a failure in database 1020.

In addition to committing the modified page to database 1020, a log entry may be generated and stored in recovery log 1040. The log entries in recovery log 1040 may describe recent changes made to database 1020, which may be used if something fails (e.g., transaction failure, system failure, media failure) in database 1020, to attempt to restore database 1020 to a state prior to the failure. Because recovery log 1040 may have a limited size, recovery log 1040 may be periodically or continuously backed up to log archive 1050. To enhance recovery speed of the database log archive 1050 may be at least partially sorted. Partially sorting log archive 1050 may involve sorting sets of log entries as they are moved from recovery log 1040 to log archive 1050. In the event of a media failure, many pages from backup 1030 may need to be restored to a replacement database 1060. In some cases, one storage media of many within database 1020 may be replaced if the media failure is limited, or the entire database 1020 may require restoration in more severe failures. In either case, backup 1030 in combination with log archive 1050 are used to restore data to in replacement database 1060 to a state the original database 1020 had prior to the media failure. In some cases, it may also be appropriate to use data in recovery log 1040 to ensure un-archived modifications to database 1020 are also restored.

In various examples, log archive sorting may facilitate restoring pages from a backup to a replacement storage media. For example, when a storage media fails, some data stores may load a full backup to a replacement storage media, then loading pages that have been updated since the full backup as from incremental and/or differential backups as appropriate. Next modifications to pages identified in the log archive and recovery log may be performed in series by loading pages from the replacement storage media, modifying the pages in memory, and then re-storing the modified pages on the replacement storage media. As pages may have multiple log entries in the log archive and in the recovery log, depending on how many modifications have occurred since the last backup, individual pages may be loaded and stored multiple times.

Further, as log records in a log archive and a recovery log are organized in chronological order, restoration processes sometimes proceed serially over the log archive and recovery log. This may cause a restoration process to determine which memory page a log entry is associated with, and then load that page for modification if it is not already in memory. If several different pages are modified in a row, memory may fill, and pages will be evicted from memory back to the replacement storage media while not fully up to date. In a bad case scenario, each time a log entry associated with an individual page is identified by the restoration process in the log archive or recovery log, the page may be loaded from the replacement media to memory, modified according to a the log entry, and then re-stored on the replacement media. This may be inefficient because loads from storage media are time consuming, especially when traditional disk drives serve as a storage media.

However, if the log archive is sorted by device identifier and page identifier in addition to time, a restoration process may be able to restore the data originally stored on the failed storage media from a backup to a replacement media in a “single pass”. This may allow pages to be restored sequentially so that once restoration of a page begins, other pages are not loaded to memory causing the page to be evicted, allowing restoration of the page to be completed before beginning restoration of a next page. Consequently, single-pass page restoration may include loading a page to memory, applying changes from change logs (e.g., log archive, recovery log) to the page, and then storing the page to the replacement media. The memory load may be directly from a backup, allowing only the most recent, correct data to be ultimately stored to the replacement media.

Though it is possible to keep a log archive fully sorted as log entries are moved to the log archive from a recovery log, this may be inefficient because sorting over large data sets, even if only inserting new log entries into an already sorted data set, may be time consuming. Thus, it may be appropriate to instead sort sets of the recovery log as the recovery log is moved to the log archive. For example, if log entries in a recovery log sometimes get moved to a log archive after the recovery log reaches a certain size or after a certain time period, these log entries may be sorted into a sorted set of log entries in the log archive. Sorting the set may be more time efficient than continually sorting log entries into a fully sorted log archive. Thus, the log archive may comprise several sorted sets of log entries.

Once a restoration process commences, the independent sets may then be merged or effectively merged into a single sorted log archive. To illustrate, the sorted log archive may only exist as a stream in memory during the restoration process. Thus, the sets of log entries may be pipelined to the restoration process as the restoration process restores pages from the backup. Alternatively, the sets of log entries may be fully sorted into a materialized sorted log archive, which may then be stored and used throughout the restoration process.

As pages are restored to a replacement media, log entries associated with each page may be retrieved from the log archive, allowing the page to have all changes from the log entries applied to the page during a single load of the page to memory. That said, there may be situations (e.g., due to an interruption of the restoration process, due to high resource demand from a higher priority process) where it is appropriate to store a page and re-load the page prior to fully updating the page. Additionally, where concurrency is possible, there may be several pages being restored at the same time.

In some examples, sorting sets of entries into a recovery log may include indexing (e.g., by partitions of a partitioned B-tree) the sets of entries from the recovery log. In this case, each set of the recovery log entries that is stored may form its own partition of a partitioned B-Tree. During restoration, partitions may be searched for log entries associated with a page being restored.

It is appreciated that, in this description, numerous specific details are set forth to provide a thorough understanding of the examples. However, it is appreciated that the examples may be practiced without limitation to these specific details. In other instances, some methods and structures may not be described in detail to avoid unnecessarily obscuring the description of the examples. Also, the examples may be used in combination with each other.

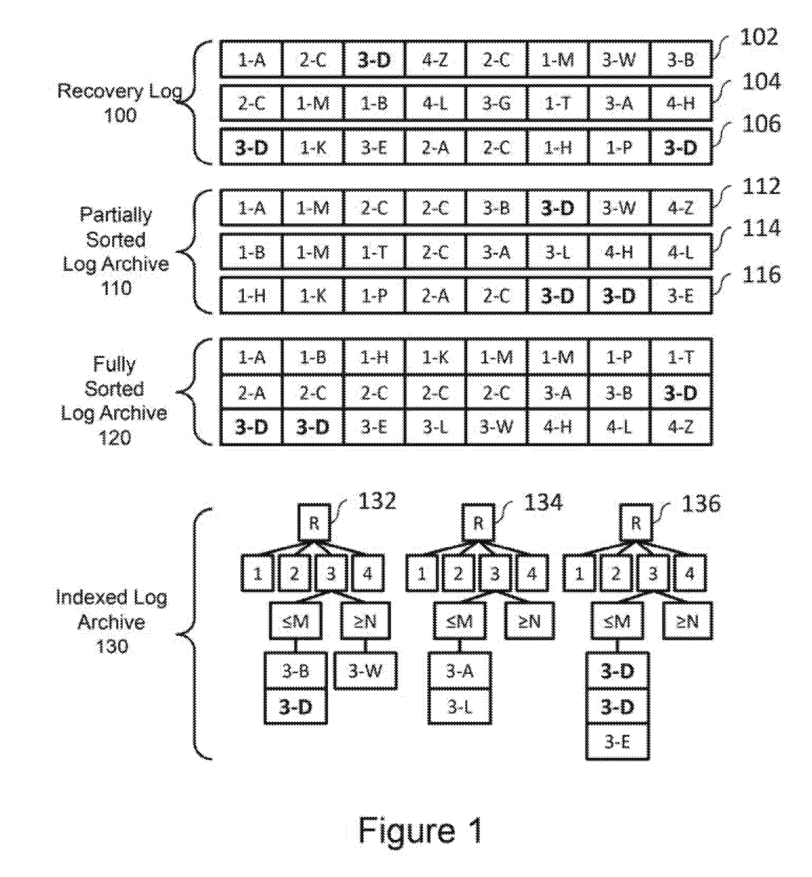

FIG. 1 illustrates example data structures associated with partially sorted log archives. The examples shown here use limited data sets for the purpose of illustrating at a high level, operations that may be performed to enhance the speed of restoring from backup to a replacement storage media, data originally stored on a failed media device. In practice, data sets may be substantially larger. In FIG. 1, boxes having the [number]-[letter] format are intended to represent log entries associated with pages in a database. The numbers, ranging from 1 to 4, represent device identifiers, and the letters, ranging from A to Z, represent page identifiers of the individual devices. In this example, each device may have pages along the full page range of A to Z. However, in other examples, it may be efficient to structure a database where devices house subsets of a single page range (e.g., device 1 has pages ranging from A to G, etc.). Log entries associated with page “D” on device “3” are emphasized throughout FIG. 1, not for a technical reason, but to illustrate example data transformations being performed on the data structures illustrated in FIG. 1.

Recovery log 100 is an example set of log entries identified by device and page identifiers. The log entries may describe changes made to pages in a database. Recovery log 100 is divided into three recovery log sets 102, 104, and 106. Sometimes, multiple sets of log entries would not exist in the recovery log simultaneously. In practice, once an archiving process has determined that it is time to store a set (e.g., due to space allocated for the recovery log filling up) in a log archive (e.g., partially sorted log archive 110), the set will be stored and a new set will begin to be created.

In this example, the sets have a fixed size of 8 log entries. Thus, in this example, sets of recovery log 100 may be configured to be moved to a log archive after a fixed number of recovery log entries. In other cases, it may be appropriate to commit recovery log entries to a log archive after a certain time period, on an ongoing basis, after reaching a certain memory threshold, and so forth. Recovery log sets 102, 104, and 106 are organized chronologically. Thus, in set 102, the log entry associated with page “Z” on device “4” (the 4-Z entry) occurred before the log entry associated with page “M” on device “1” (the 1-M entry). Additionally, the sets themselves are organized chronologically. Thus, log entries in recovery log set 102 occurred before log entries in recovery log set 104, and so forth.

When it comes time to move sets of recovery log 100 to a log archive, a process may sort the sets and store the sets as partially sorted log archive 110. Thus, recovery log set 102 may be sorted and stored as log archive set 112, recovery log set 104 may be sorted and stored as log archive set 114, and recovery log set 106 may be sorted and stored as log archive set 116. In this example, the sorting is performed by device identifier and then by page identifier. Thus, though the 4-Z entry occurred chronologically before the 1-M entry, in log archive set 112, the 1-M entry is sorted to be before the 4-Z entry. This reordering may not create database inconsistencies during a future restoration because changes associated with the 1-M entry may not overwrite changes associated with the 4-Z entry because the entries are associated with different pages.

The log archive sets may also be sorted by time in addition to sorting by device and page identifiers. By way of illustration, recovery log set 102 has two log entries listed associated with page “C” on device “2” (the 2-C entries). Depending on the method used to sort recovery log set 102 into log archive set 112, the ordering of these two log entries may be naturally maintained. However, other sorting methods may require timestamps of log entries to be examined to maintain their original ordering so that during restoration, a log entry does not overwrite another log entry that occurred later in time.

When a media failure is detected and data originally stored on a failed media device begins to be restored to a replacement media, the sets of partially sorted log archive 110 may be used as a pail of the restoration process. In one example, the sets may be pipelined to the restoration process as the restoration process restores the database. By way of illustration a pointer may be maintained to the entry of each set of partially sorted log archive 110 that is next within the respective sets to be restored. Once a page is restored associated with one of these entries, the pointer may be moved to the next entry in the set, at which point, if that next entry is associated with the same page, that next entry may also be applied to the page. If that next entry is associated with a page that is not yet being restored, the restoration process may continue to examine entries in a subsequent set of partially sorted log archive 110 to determine if they need to be applied to the page currently being restored.

In another example, a fully sorted log archive 120 may be generated. Unlike recovery log 100 and partially sorted log archive 110, fully sorted log archive 120 may be essentially un-segmented. This may facilitate fast traversal of fully sorted log archive 120 because multiple sets may not need to be traversed for log entries. Traversal of multiple sets may be slower because log entries may reside in different areas of sets depending on how log entries within individual sets are distributed over various devices and page ranges. Additionally, traversing multiple sets may be slower in aggregate than traversing a single larger set. However, generating fully sorted log archive 120 may be time inefficient, and it may be faster to begin restoration of a database using the pipelining approach described above.

Fully sorted log archive 120 may be generated by merging sets from partially sorted log archive 110. For example, across log archive sets 112, 114, and 116, there are four 2-C entries associated with page “C” on device “2”. After merging log archive sets 112, 114, and 116 into fully sorted log archive 120, these 2-C entries are now arranged consecutively within fully sorted log archive 120. As mentioned above, chronological ordering may be maintained either naturally or by examining time stamps, depending on how the merging function is designed. Once fully sorted log archive 120 has been provided to a restoration logic, the restoration logic may be able to quickly find log entries in the log archive associated with pages being restored to a replacement storage media. Further, because log entries associated with a page have been sorted into consecutive positions within fully sorted log archive 120, all changes to be made to the page, as indicates by log entries in fully sorted log archive 120, can be applied sequentially, before beginning restoration of another page, and without evicting the page from memory. This may reduce the number of times the page has to be stored to the replacement media, and then loaded so that an additional change can be applied to the page.

In an alternative example, sorting recovery log 100 may include generating an indexed log archive 130. As mentioned above, the indexed log archive may be composed of several partitions of a partitioned B-Tree. In this example, sets 102, 104, and 106 of recovery log 100 are indexed by partitions 132, 134, and 136 of indexed log archive 130 respectively. Due to space limitations in FIG. 1, only a portion of the partitions 132, 134, and 136 are illustrated, and each has several pointers and nodes that are not shown.

In this example, each partition contains a root node “R” with links pointing to each of the devices 1 through 4. Each of the devices then divides log entries based on page identifier, where a list of log entries originating from the respective recovery log set is stored. When indexed log archive 130 is used for storing log entries instead of sorted log archive 110, it may be inefficient to fully merge the log archive 120 when initiating restoration. This is because similarly structured partitions may facilitate fast traversal because the same path may be taken through each partition.

By way of illustration, consider an example where storage media 3 has had a media failure and page 3-D is in the process of being restored. A restoration process may begin by loading the most recent image of page 3-D from a backup, and then begin traversing partitions of indexed log archive 130. First, partition 132 may be traversed from the root, to the node associated with storage media 3, and finally to the node for pages less than or equal to M. At this point, a list of log entries may be traversed until the restoration process finds log entries associated with page 3-D. Next, partitions 134 and 136 may be similarly traversed. In fact, depending on how data is structured, it may be possible to skip a full traversal of partitions 134 and 136. In this case, if locations of nodes in memory describing partitions are similar, the restoration process may proceed directly to log entry lists once the restoration process has found where log entries associated with page 3-D within partitions are stored within the respective partitions.

In addition to indexing, a bit vector filter may be generated for each partition. The bit vector filter may indicate whether a page on a device (e.g., 3-D) has a log entry within a partition. By way of illustration, bit vector filters for partitions 132 and 136 may indicate that there is a log entry associated with page 3-D within their respective partitions, whereas a bit vector filter for partition 134 may indicate that there is not a log entry associated with page 3-D within partition 134. This may allow a recovery process to quickly determine whether it is worthwhile to traverse a partition.

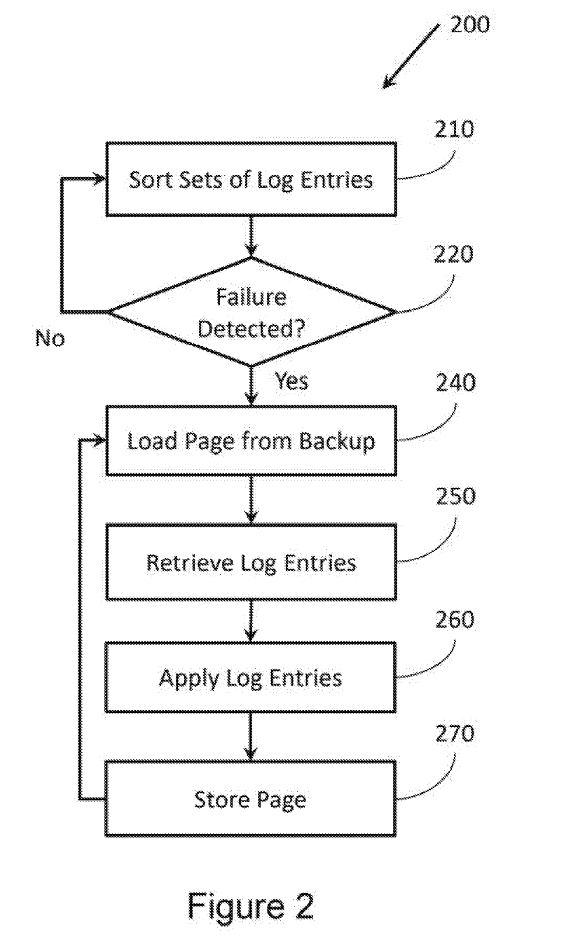

FIG. 2 illustrates a method 200 associated with partially sorted log archives. Method 200 includes sorting sets of log entries at 210. The log entries may be from a recovery log of a database. Sorting the sets of log entries at 210 may generate an at least partially sorted log archive. The sets of log entries may be sorted according to device identifier, page identifier and time. Sorting by device identifier may facilitate restoration of a failed storage media without traversing log entries or functional storage media in the log archive. By way of illustration, if a database stores data on eight different storage media, transactions in the log archive occurring on each of the storage media may be grouped together within the log archive. Thus, if the first storage media fails, a restoration process can quickly find log entries associated with the failed storage media, speeding up restoration of data from a backup.

Sorting sets of log entries by page identifier may allow a process restoring data from a backup to process log entries associated with a single device in a single pass. This may allow each page to be loaded from backup, modified according to log entries in the log archive, and stored to a replacement media without performing intermediate stores and loads of the page. Log entries in the log archive may also be sorted by time. In one example, as log archives are sometimes generated over time as actions occur in a database, log entries in the log archives may naturally be sorted by time without any special action being taken. Other methods of sorting may also be appropriate. Ensuring log entries remain organized by time may ensure that older data does not overwrite newer data on the replacement media.

Method 200 also includes detecting a failure of a failed storage media from the database at 220. Upon detecting the failure at 220, method 200 includes performing actions for members of a set of pages originally stored on the failed storage media. First, method 200 includes loading a page from the set of pages from a backup to memory at 240. Next, method 200 includes retrieving log entries associated with the page from the sets of log entries at 250. The log entries may be retrieved at 250 by obtaining the entries directly from their locations in the partially sorted log archive via a pipelining approach, or by materializing a fully sorted log archive as a result of merging various sets of log entries in the partially sorted log archive.

Method 200 also includes applying log entries associated with the page to the page at 260. Method 200 also includes storing the page from memory to a replacement storage media at 270. Upon storing the page at 270, method 200 may begin repeating loading action 240, retrieving action 250, applying action 260, and storing action 270 for each page in the set of pages originally stored on the failed storage media.

In one example, sorting sets of log entries may also include indexing the sets of log entries into respective partitions of a partitioned b-tree. By way of illustration, a first set of log entries may be indexed by a first partition of a partitioned b-tree, a second set of log entries may be indexed by a second partition of a partitioned b-tree, and so forth. Indexing sets of recovery log entries may reduce the time it takes to restore a portion of a database because retrieving log entries associated with individual pages from an index may facilitate quick restoration of the pages. In this example, retrieving log entries associated with the page may comprise retrieving log entries associated with the page from the partitions of the partitioned b-tree.

For indexed partitions, it may be useful to generate bit vector filters for each partition. A bit vector filter may contain a bit associated with each page on each storage media in a database. When a partition contains a log entry associated with a page, the bit associated with that page may have a first value (e.g., 1). When the partition does not contain a log entry associated with a page, the bit associated with that page may have a second value (e.g., 0). Consequently, indexing sets of log entries by the indexed b-tree may include generating bit vector filters that describe contents of the partitions. When retrieving log entries from indexed partitions, bit vector filters may be examined before traversing an indexed partition to quickly determine whether an entry associated with a page has been stored within the partition.

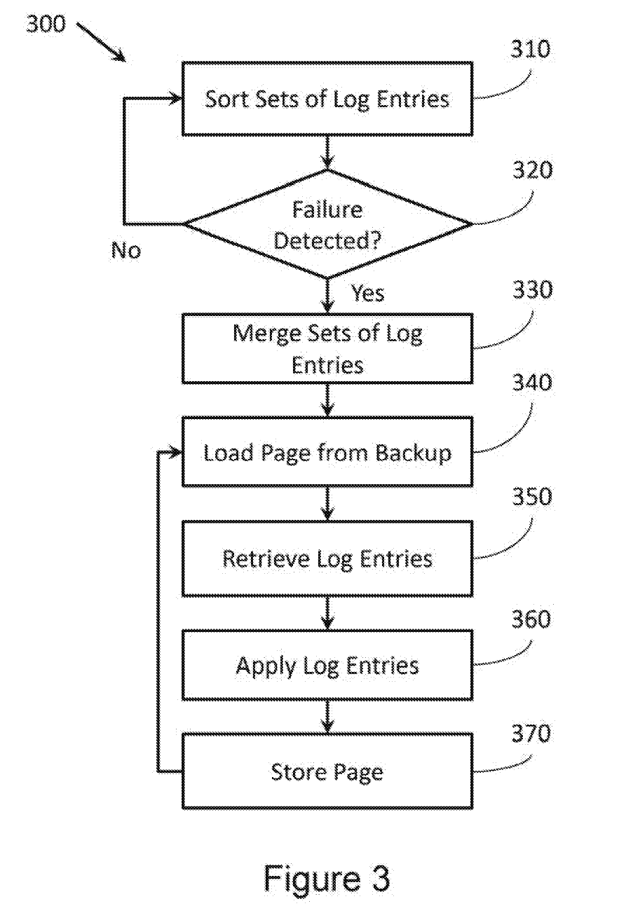

FIG. 3 illustrates a method 300 associated with partially sorted log archives. Method 300 includes several actions similar to those described above with reference to method 200 (FIG. 2). For example, method 300 includes sorting sets of log entries at 310 into an at least partially sorted log archive, detecting a failure of a failed storage media at 320, loading a page from a backup at 340, retrieving log entries at 350, applying the log entries to the page at 360, and storing the page at 370.

Method 300 also includes merging sets of log entries from the partially sorted log archive into a fully sorted log archive. In this example, the log entries may be retrieved at 350 from the fully sorted log archive instead of from the partially sorted log archive.

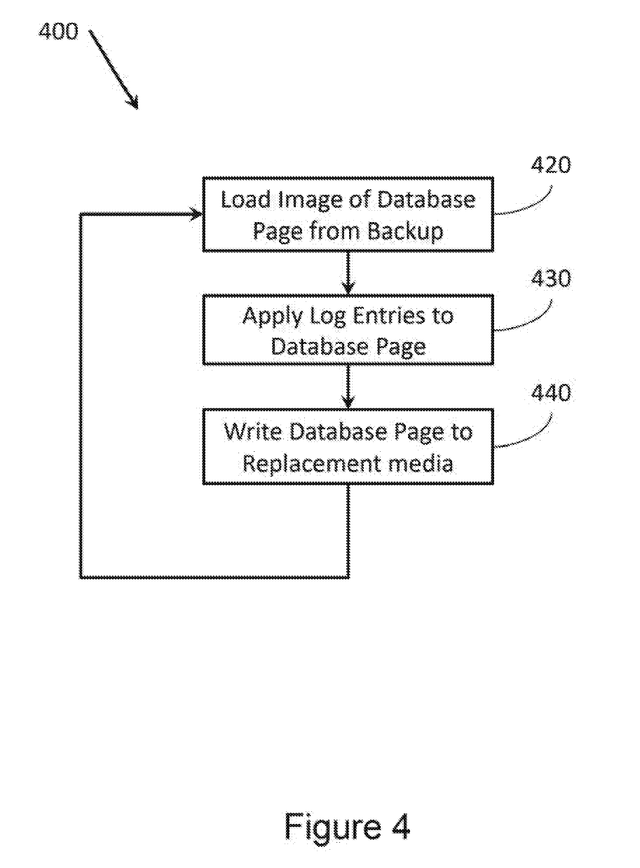

FIG. 4 illustrates a method 400 associated with partially sorted log archives. Method 400 may be, for example a method for restoring a database. Method 400 may be performed for members of a set of database pages originally stored on a failed media device in the database. Consequently, method 400 may be performed for each member of the set of database pages being restored. Method 400 includes loading an image of a database page from a backup at 420. The backup may be, for example, a tape drive, a storage media, and so forth. Additionally, the backup may take the form of one or more of, a full backup, an incremental backup, a differential backup, and so forth. The incremental backup and/or the differential backup may be sorted, for example, by device identifier, page identifier, and time. Thus, loading an image of a database page from the backup may include loading an image of the database from a full backup, or loading the image from one of an incremental backup and a differential backup when the page has been modified since a recent full backup. Whether a page has an entry in an incremental backup or a differential backup may be determined by, for example, examining a bit mask filter associated with the incremental backup of differential backup.

Method 400 also includes applying log entries associated with the member of the set of database pages to the database page at 430. The log entries may have been recorded after the image of the member of the set of the database pages was taken. The log records may be retrieved from an at least partially sorted log archive. The partially sorted log archive may be sorted according to, for example, device identifier, page identifier, and time. In another example, the partially sorted log archive may be a partitioned b-tree. In this example, log entries may be retrieved from the partitioned b-tree by traversing partitions of the partitioned b-tree. Method 400 also includes writing the database page to a replacement media at 440.

In one example, actions 420, 430, and 440 may be steps repeatedly taken in sequence as a part of restoring a database from a backup by restoring individual pages. Thus, the restoration of the database page loaded from backup at action 420 may be completed before beginning restoration of a next database page.

By way of illustration, some restoration techniques may apply log entries to database pages in in the order these log records were written during pre-failure transaction processing. Consequently, some restoration techniques of a database may not be certain that a database page is up to date until the last log entry has been applied to its respective database page. This may prevent accesses to the entire database until the last log entry has been applied, because the system cannot be sure which pages are up to date until the last log entry has been applied. When backups and log entries are sorted, method 400 illustrates how a restoration process may be certain that a database page is fully restored prior to restoration of the entire database, and therefore requests associated with that database page may be responded to prior to restoration of the entire database.

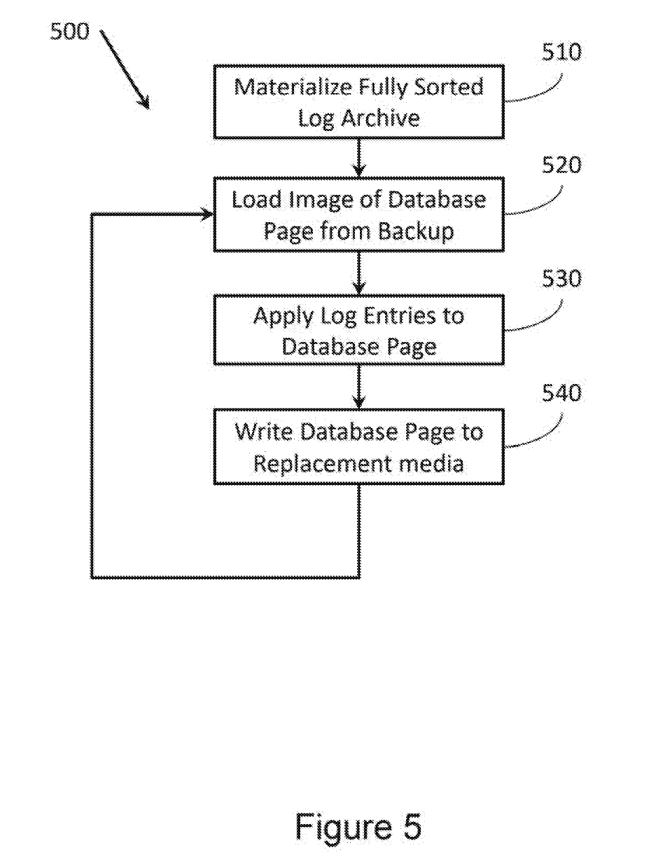

FIG. 5 illustrates a method 500 associated with partially sorted log archives. Method 500 includes several actions similar to those described above with reference to method 400 (FIG. 4). For example, method 500 includes loading an image of a database page from a backup at 520, applying log entries to the database page at 530, and writing the database page to a replacement media at 540. Method 500 also includes materializing a fully sorted log archive by merging runs of an at least partially sorted log archive at 510. As described above, the partially sorted log archive may be generated by sorting sets of log entries from a recovery log as the recovery log fills up. These sets may be referred to as “runs” as the term is used when describing run generation for a merge sort. Unlike a traditional merge sort where the merging is performed after run generation is completed, merging to materialize the fully sorted log archive may be delayed until after a failure is detected and the log entries are needed to facilitate restoration. This may facilitate performing a single merge on a number of log entries that grows over time between backups, which may be more efficient than maintaining a fully sorted log archive during normal database operation.

Additionally, generating the sorted log archive prior to beginning sequential restoration of the database may facilitate sequential restoration of pages by grouping together log entries associated with individual pages within the log archive. Because some systems do not group log entries associated with individual pages within the log archive, log entries associated with individual pages may be spread throughout the log archive. This may cause a page to be evicted from memory (e.g., stored to the replacement storage media) before all log entries associated with the page are applied to the page. Evicting a page from memory to a replacement storage media, and loading a page to memory from the replacement storage media may be relatively slow operations. Thus, a sorted log archive that facilitates sequential restoration of pages may reduce the number of loads and stores to the replacement storage media during the restoration process, thereby reducing the time it takes to complete restoration. Additionally, sequentially restored pages may be accessible prior to completion of restoration of the full database because a restoration process may be sure that all modifications to the database page identified in backups and/or log entries are applied to pages before moving on to restoration of a next page.

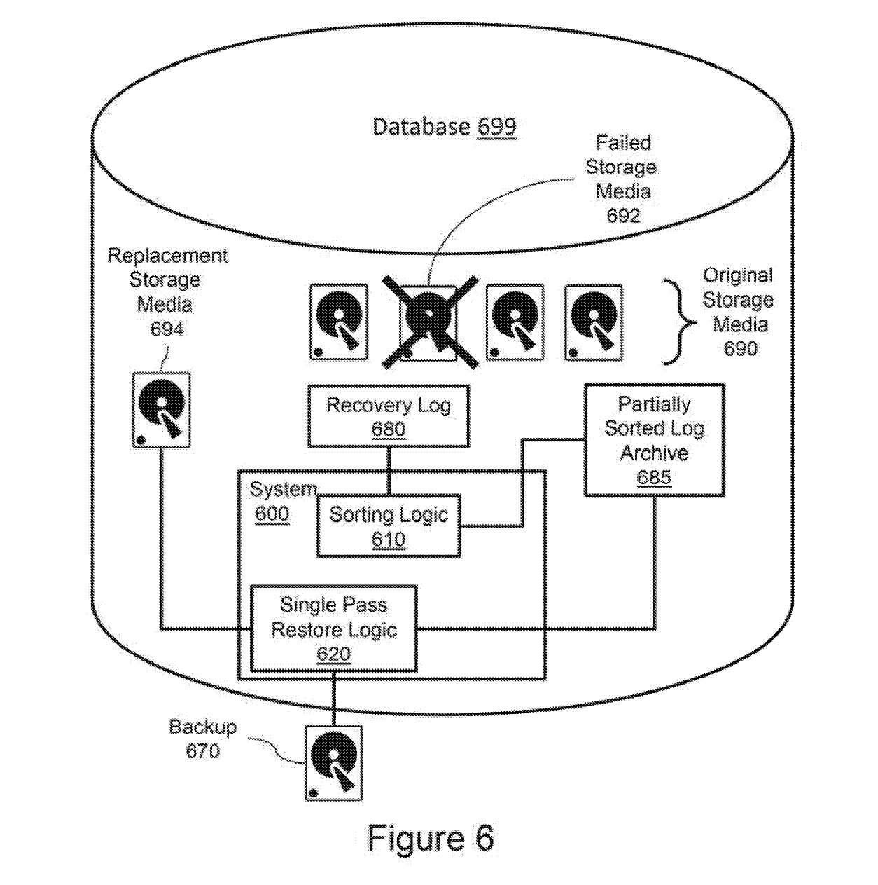

FIG. 6 illustrates an example system 600 associated with log archive sorting. System 600 may be a part of a database 699 and may be used to facilitate quick restoration of data from a backup 670 to a replacement storage media 694, after a media failure in an original storage media 690 (creating a failed storage media 692).

System 600 includes a sorting logic 610. Sorting logic 610 may sort sets of entries from a recovery log 680 as transactions are occurring in database 699. As described above, the sets of entries may be selected based on, for example, a fixed size, a time period, and so forth. Sorting logic 610 may also store sorted sets of recovery log 680 as an at least partially sorted log archive 685. In one example, partially sorted log archive 685 may be a partitioned b-tree. In this example, sorting logic 610 may index sets of entries into respective partitions of the partitioned b-tree.

System 600 also includes a single pass restore logic 620. Single pass restore logic 620 may sequentially restore database pages to replacement storage media 594 in response to a failure of an original storage media 690. In one example, single pass restore logic 620 may selectively prioritize for sequential restoration, a requested database page upon detecting a data access associated with the requested database page. Prioritizing a database page for restoration may facilitate responding to requests for data originally on failed storage media 692 while restoration of that data to replacement storage media 694 is in process. In other examples, data may be prioritized for restoration based on, for example, frequent use, recent use, data importance, and so forth.

Sequentially restoring database pages may include loading a database page originally stored on the original storage media (now failed storage media 692) from a backup 670. The backup may include a full backup, incremental backups, differential backups, and so forth.

Sequentially restoring a database page may also include applying log entries associated with the database page from partially sorted log archive 685 to the database page. The log records associated with the database page may be obtained from partially sorted log archive 685 by, for example, merging sorted portions of log archive 685 into a single sorted portion and then obtaining the log records associated with the database page from the fully sorted log archive. Alternatively, log records associated with the database page may be obtained individually from within partially sorted log archive 685 via pipelining. In the example, where the sorting logic indexes sets of the recovery log by a partition of a partitioned B-Tree, single pass restore logic 620 may obtain log records associated with the database page from partitions of the partitioned B-Tree composing log archive 685 by traversing partitions of the partitioned B-Tree. The traversal may be performed based on a device identifier of the original storage media (now failed storage media 692), and based on a page identifier of the database page being restored. Sequentially restoring the database page may also include writing the database page to replacement storage media 694.

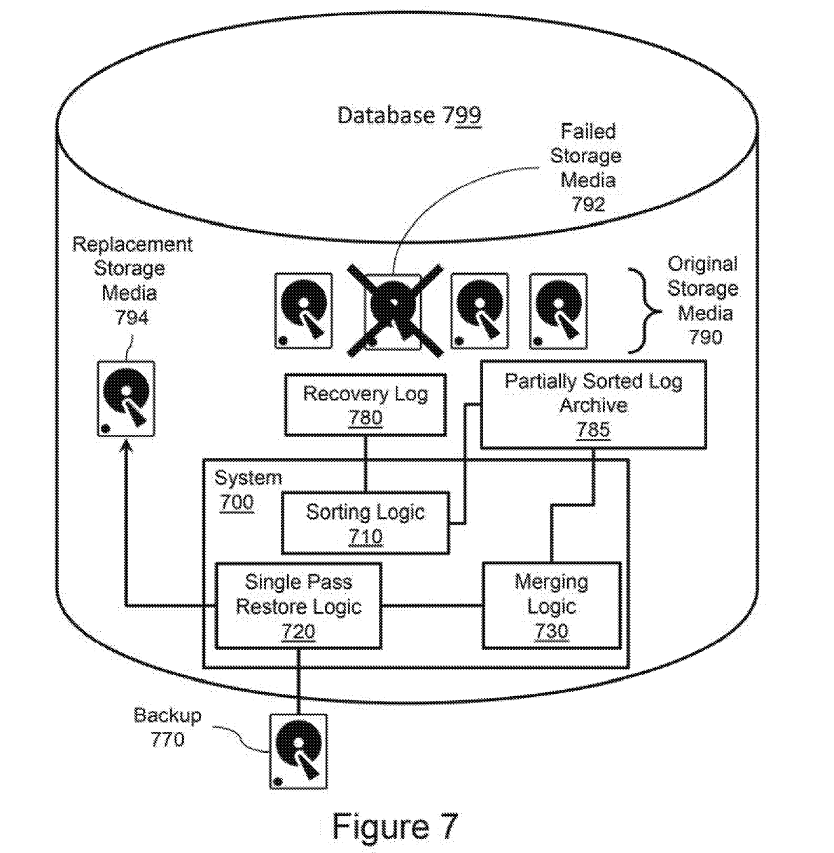

FIG. 7 Illustrates a system 700 associated with log archive sorting. System 700 includes several elements similar to those described above with reference to system 600 (FIG. 6). For example, system 700 resides within a database 799 having several original storage media 790, and a replacement storage media 794. One of the original storage media 690 has failed, becoming failed storage media 792. Additionally, database 799 is associated with a backup 770. System 700 includes a sorting logic 710 to sort log entries from recovery log 780 into an at least partially sorted log archive 785, and a single pass restore logic 720 to sequentially restore database pages to replacement storage media 794 in response to the failure of failed storage media 792.

System 700 also includes a merging logic 730. Merging logic 730 may merge sets of the partially soiled log archive 785 into a sorted log archive. The merging may occur when single pass restore logic 720 begins restoring database pages to replacement storage media 794 Merging logic 730 may also provide the sorted log archive to single pass restore logic 720.

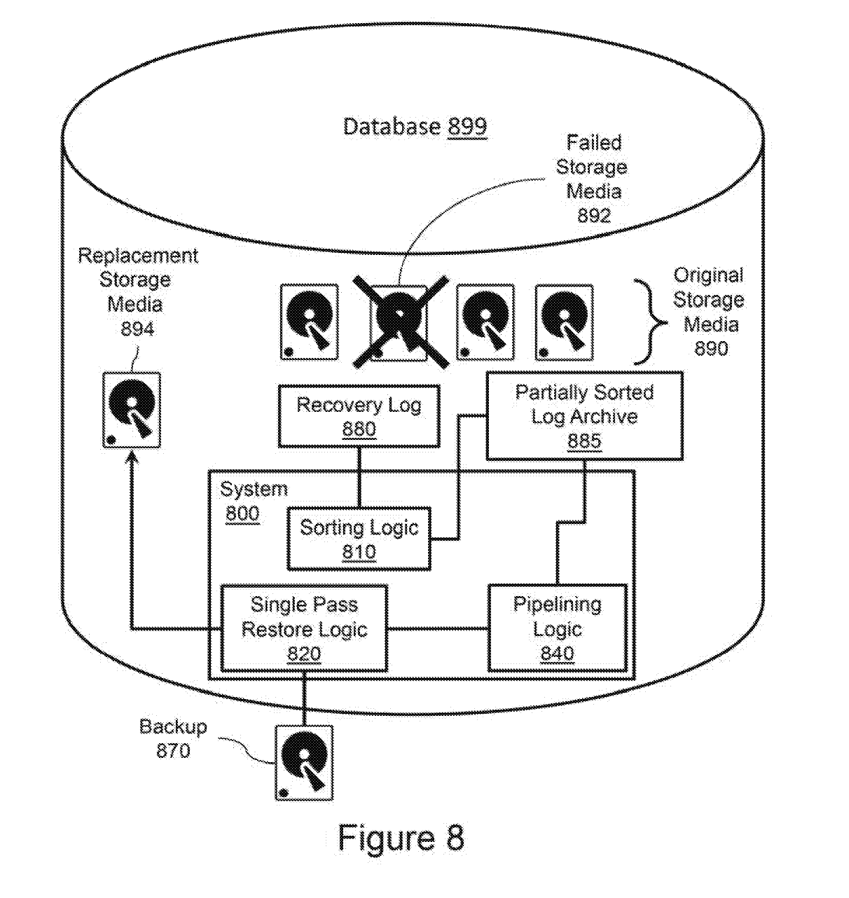

FIG. 8 illustrates a system 800 associated with log archive sorting. System 800 includes several elements similar to those described above with reference to system 600 (FIG. 6). For example, system 800 resides within a database 899 having several original storage media 890, and a replacement storage media 894. One of the original storage media 890 has failed, becoming failed storage media 892. Additionally, database 899 is associated with a backup 870. System 800 includes a sorting logic 810 to sort entries from recovery log 880 into an at least partially sorted log archive 885, and a single pass restore logic 820 to sequentially restore database pages to replacement storage media 894 in response to the failure of failed storage media 892.

System 800 also includes a pipelining logic 840. Pipelining logic 840 may process requests for log records associated with database pages from single pass restore logic 820. Upon receiving a request for log records associated with a database page, pipelining logic 840 may provide log records associated with the database page to single pass restore logic 820. Selection logic may obtain these log records by traversing sorted sets of partially sorted log archive 885.

Whether one opts to use a system having a merging logic (e.g., merging logic 730, FIG. 7) or a pipelining logic (e.g., pipelining logic 840, FIG. 8) may depend on a chosen format of a partially sorted log archive. For example, when the partially sorted log archive is merely sorted by device and page identifiers (e.g., unindexed), it may be efficient to use a sorting logic to pre-sort the log archive before performing data restoration. This is because repeatedly traversing unindexed lists for log entries may be inefficient. However, if indexes are used when sorting and storing a partially sorted log archive, traversing indexed data may be sufficiently fast that performing sorting on the entire log archive prior to data restoration is unnecessary.

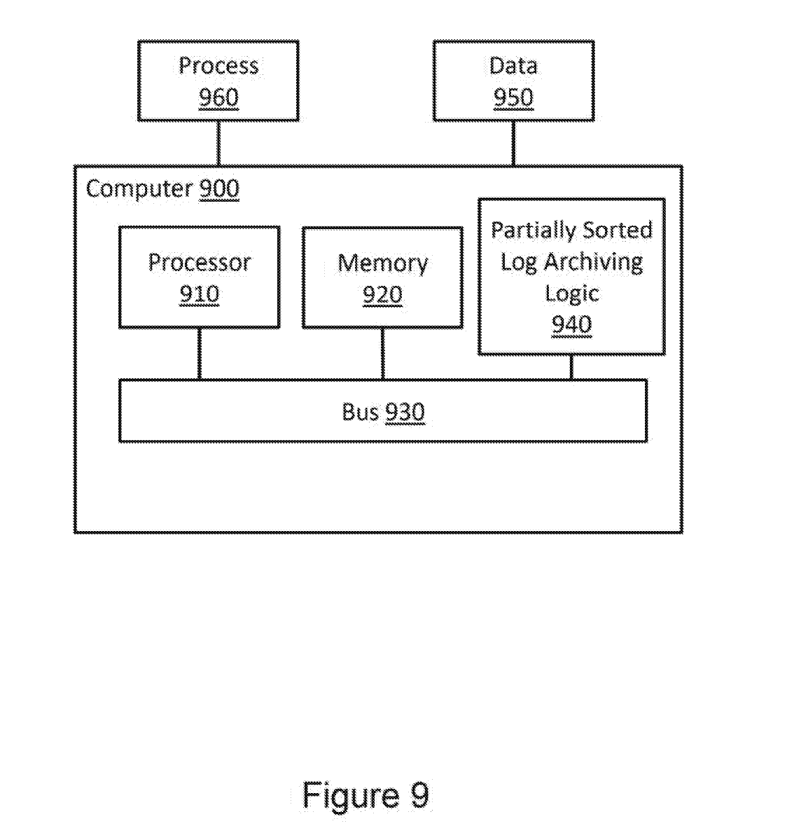

FIG. 9 illustrates an example computing environment in which example systems and methods, and equivalents, may operate. The example computing device may be a computer 900 that includes a processor 910 and a memory 920 connected by a bus 930. The computer 900 includes a log archive sorting logic 940. In different examples, log archive sorting logic 940 may be implemented as a non-transitory computer-readable medium storing computer-executable instructions in hardware, software, firmware, an application specific integrated circuit, and/or combinations thereof.

The instructions may also be presented to computer 900 as data 950 and/or process 960 that are temporarily stored in memory 920 and then executed by processor 910. The processor 910 may be a variety of various processors including dual microprocessor and other multi-processor architectures. Memory 920 may include volatile memory (e.g., read only memory) and/or non-volatile memory (e.g., random access memory). Memory 920 may also be, for example, a magnetic disk drive, a solid state disk drive, a floppy disk drive, a tape drive, a flash memory card, an optical disk, and so on. Thus, memory 920 may store process 960 and/or data 950. Computer 900 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
sorting sets of log entries from a recovery log of a database to generate an at least partially sorted log archive; and
upon detecting a failure of a failed storage media from the database, for a set of pages originally stored on the failed storage media:
loading a page from the set of pages from a backup to memory;
retrieving log entries associated with the page from the sets of log entries;
applying the log entries associated with the page to the page; and
storing the page from memory to a replacement storage media.

2. The method of claim 1, where the sets of log entries are is sorted by device identifier, by page identifier, and by time.

3. The method of claim 1, where the log entries associated with the page are retrieved from the sets of log entries via pipelining.

4. The method of claim 1, comprising merging the sets of log entries from the at least partially sorted log archive into a fully sorted log archive, and where the log entries are retrieved from the fully sorted log archive.

5. The method of claim 1, where sorting sets of log entries comprises indexing the sets of log entries into respective partitions of a partitioned b-tree, and where retrieving log entries associated with the page comprises retrieving log entries associated with the page from the partitions of the partitioned b-tree.

6. A method for restoring a database, comprising:
for each member of a set of database pages originally stored on a failed media device in the database, restoring a member of the set of database pages by:
loading an image of the member of the set of database pages from a backup;
applying log entries associated with the member of the set of database pages to the image, where the log entries were recorded after the image of the member of the set of database pages was taken, and where the log entries are retrieved from an at least partially sorted log archive; and
writing the database page to a replacement media.

7. The method for restoring a database of claim 6, where loading an image of a database page from the backup comprises one of:
loading the image of the database page from a full backup; and
loading the image from one of an incremental backup and a differential backup when the page has been modified since a recent full backup.

8. The method for restoring a database page of claim 6, comprising materializing a fully sorted log archive by merging runs of the at least partially sorted log archive.

9. The method for restoring a database of claim 6, where log entries are sorted according to device identifier, page identifier, and time.

10. The method for restoring a database of claim 6, where the at least partially sorted log archive is a partitioned b-tree, and where log entries are retrieved from the partitioned b-tree by traversing partitions of the partitioned b-tree.

11. A system, comprising:
a sorting logic to sort sets of entries from a recovery log of a database as transactions are occurring in the database, and to store the sets as an at least partially sorted log archive;
a single pass restore logic to sequentially restore database pages to a replacement storage media in response to a failure of an original storage media by: loading a database page originally stored on the original storage media from a backup, applying log entries associated with the database page from the at least partially sorted log archive to the database page, and writing the database page to the replacement storage media.

12. The system of claim 11, comprising a merging logic to merge sets of the at least partially sorted log archive into a sorted log archive when the single pass restore logic begins restoring database pages to the replacement storage media, and to provide the sorted log archive to the single pass restore logic.

13. The system of claim 11, comprising a pipelining logic to pipeline sets of log entries from the at least partially sorted log archive to the single pass restore logic.

14. The system of claim 13, where the at least partially sorted log archive is a partitioned b-tree, where the sorting logic indexes sets of entries into respective partitions of the partitioned b-tree and where the pipelining logic retrieves log entries from the partitioned b-tree by traversing partitions of the partitioned b-tree.

15. The system of claim 11 where the single pass restore logic selectively prioritizes a requested database page upon detecting a data access associated with the requested database page.
